(19) United States
(12) Patent Application Publication
(10) Pub. No.: US 2025/0291094 A1
(43) Pub. Date: Sep. 18, 2025

(54) OPTICAL ELEMENT AND LIGHT RECEIVING OPTICAL SYSTEM

(71) Applicant: KONICA MINOLTA, INC., Tokyo (JP)

(72) Inventors: Masaki IWAMA, Tokyo (JP); Mitsuru YOKOYAMA, Osaka (JP)

(73) Assignee: KONICA MINOLTA, INC., Tokyo (JP)

(21) Appl. No.: 19/071,779

(22) Filed: Mar. 6, 2025

(30) Foreign Application Priority Data
Mar. 13, 2024 (JP) 2024-039133

(51) Int. Cl. G02B 3/08

(52) U.S. Cl. CPC G02B 3/08

(57) ABSTRACT

Provided is an optical element that is disposed closer to an object side than a light receiving surface is. The optical element includes: a base material; and a planar optical functional layer including a plurality of microstructures arranged on the base material. The light receiving surface is formed in a rectangular shape having a long axis and a short axis, and a plurality of light receiving elements are arranged in a lattice pattern along the long axis and the short axis on the light receiving surface. The plurality of microstructures is arranged in a lattice pattern along two basic translation vectors. One of the basic translation vectors is parallel to at least one of the long axis and the short axis of the light receiving surface.

### CROSS-REFERENCE TO RELATED APPLICATIONS

The entire disclosure of Japanese Patent Application No. 2024-039133 filed on Mar. 13, 2024, is incorporated herein by reference in its entirety.

### BACKGROUND OF THE INVENTION

### Technical Field

The present invention relates to an optical element and a light receiving optical system that include an optical functional layer in which a plurality of microstructures is arranged.

### Description of Related Art

There is a known technique in which a plurality of microstructures arranged in a lattice pattern provides phase modulation to light to exert an optical function like a lens or a prism.

For example, Japanese Unexamined Patent Publication No. 2023-110453 discloses a metalens in which fine nanostructures are arranged in a square lattice pattern. Japanese Unexamined Patent Publication No. 2015-92234, discloses a lens in which unit cells are arranged in a square lattice pattern or a hexagonal lattice pattern.

However, Japanese Unexamined Patent Publication No. 2023-110453 and Japanese Unexamined Patent Publication No. 2015-92234 do not refer to the relation between the shape of the light receiving surface having a plurality of light receiving elements and the microstructure arrangement. In an optical element having a lattice-like fine structure, the interaction with light changes depending on the direction of the lattice, and therefore, it is desirable that the arrangement of the microstructures can be optimized in accordance with the shape of the light receiving surface.

The present invention has been made in consideration of the above-described circumstances, and an object thereof is to appropriately arrange a plurality of microstructures with respect to the shape of a light receiving region having a plurality of light receiving elements.

### SUMMARY OF THE INVENTION

To achieve at least one of the abovementioned objects, according to an aspect of the present invention, an optical element reflecting one aspect of the present invention is disposed closer to an object side than a light receiving surface is, the optical element including:
a base material; and a planar optical functional layer including a plurality of microstructures arranged on the base material,
wherein the light receiving surface is formed in a rectangular shape having a long axis and a short axis, and a plurality of light receiving elements are arranged in a lattice pattern along the long axis and the short axis on the light receiving surface,
wherein the plurality of microstructures is arranged in a lattice pattern along two basic translation vectors,
wherein one of the basic translation vectors is parallel to at least one of the long axis and the short axis of the light receiving surface.

According to another aspect of the present invention, a light receiving optical system reflecting another aspect of the present invention includes:
a light receiving surface; and
a planar optical functional layer that is disposed closer to an object and that includes a plurality of microstructures arranged on a base material,
wherein the light receiving surface is formed in a rectangular shape having a long axis and a short axis, and a plurality of light receiving elements are arranged in a lattice shape along the long axis and the short axis on the light receiving surface,
wherein the plurality of microstructures is arranged in a lattice pattern along two basic translation vectors,
wherein one of the basic translation vectors is parallel to at least one of the long axis and the short axis of the light receiving surface.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a light receiving optical system according to an embodiment;

FIG. 2 is a plan view of a light receiving surface according to the embodiment and shows an arrangement of a plurality of light receiving elements on the light receiving surface;

FIG. 3 is a plan view of an optical functional layer in which a plurality of microstructures are arranged in a square lattice shape according to the embodiment;

FIG. 4 is a partial enlarged view of FIG. 3;

FIG. 5 is a plan view of an optical functional layer according to a comparative example of the embodiment;

FIG. 6 is a plan view of an optical functional layer in which a plurality of microstructures are arranged in a face-centered rectangular lattice shape according to the embodiment;

FIG. 7 is a partial enlarged view of FIG. 6;

FIG. 8 is a plan view of an optical functional layer in which a plurality of microstructures are arranged in a rectangular lattice shape according to the embodiment;

FIG. 9 is a plan view of an optical functional layer according to a comparative example of the embodiment;

FIG. 10A shows an example of an arrangement of shapes of microstructures according to the embodiment, which is based on the XY polynomials;

FIG. 10B shows an example of an arrangement of shapes of microstructures according to a comparative example of the embodiment, which is based on an even-aspherical surface; and

FIG. 11 shows a light receiving optical system according to a modification example of the embodiment.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described with reference to the drawings.

### [Overall Configuration of Light Receiving Optical System]

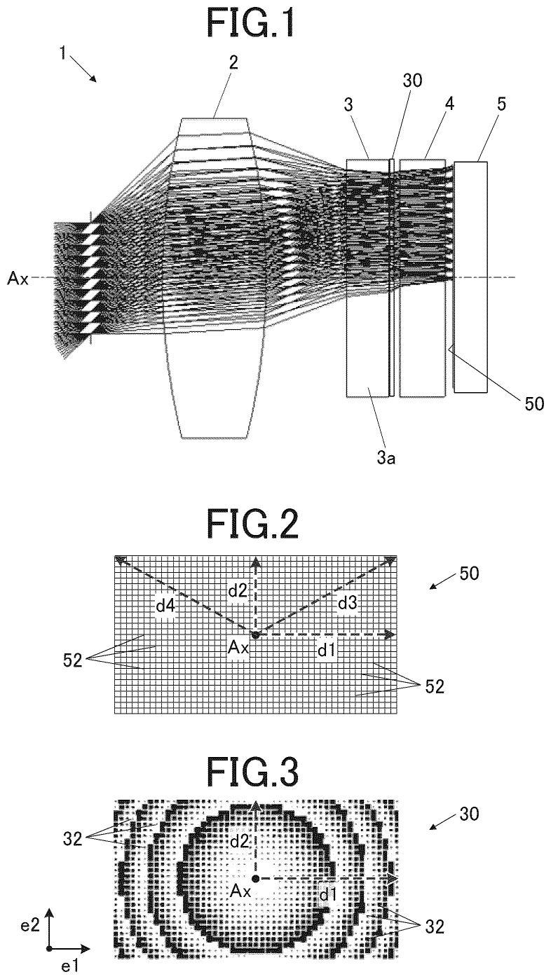

FIG. 1 shows a light receiving optical system 1 according to the present embodiment.

As shown in FIG. 1, the light receiving optical system 1 includes a lens 2, a first parallel plate 3, a second parallel plate 4, and a light receiving sensor 5 in this order from the object side (left side in FIG. 1).

The lens 2 is, for example, a convex lens having a predetermined power.

The first parallel plate 3 has, on an image side (right side in FIG. 1) surface of a base material 3a such as a silicon substrate or a glass substrate, a flat optical functional layer (optical functional surface) 30 orthogonal to the optical axis Ax of the light receiving optical system 1. The first parallel plate 3 is an example of an optical element according to the present embodiment. The optical functional layer 30 will be described later.

The second parallel plate 4 is, for example, a cover glass that protects the light receiving sensor 5 (the light receiving surface 50).

FIG. 2 is a plan view of the light receiving sensor 5 (light receiving surface 50) showing an arrangement of a plurality of light receiving elements 52 on the light-receiving surface 50.

The light receiving sensor 5 has a light receiving surface 50 as a photoelectric conversion section that photoelectrically converts incident light.

As shown in FIG. 2, (the optical opening of) the light receiving surface 50 is formed in a plane shape orthogonal to the optical axis Ax and in a rectangular shape having a long axis d1 and a short axis d2. The light receiving surface 50 of the present embodiment has, for example, a rectangular shape with an aspect ratio of 16:9 between the width (long side) and the height (short side).

On the light receiving surface 50, the plurality of light receiving elements 52 which are photoelectric conversion elements are arranged in a lattice shape along the long axis d1 and the short axis d2.

### [Optical Functional Layer]

FIG. 3 is a plan view of the optical functional layer 30.

As shown in this figure, the optical functional layer 30 is a so-called metasurface and includes a plurality of microstructures 32 arranged on the base material 3a. The microstructures 32 are so-called metaatoms and are fine structure bodies having a size equal to or smaller than the main design wavelength of the optical function layer 30. The plurality of microstructures 32 exert various optical functions including refraction, diffraction, and the like as a difference in shape between adjacent microstructures 32 causes a phase gradient to act on light.

The (optical opening of the) optical function layer 30 is formed in a planar shape orthogonal to the optical axis Ax and in a rectangular shape having a long axis and a short axis in the same direction as the light receiving surface 50. However, the planar shape of the optical functional layer 30 is not particularly limited, and may be a rectangular shape in which the directions of the long axis and the short axis are different from those of the light receiving surface 50, or may not be a rectangular shape.

### [Arrangement of Microstructures]

The plurality of microstructures 32 are two dimensionally arranged in a lattice shape along two basic translation vectors e1 and e2 in a plane orthogonal to the optical axis Ax. At least one of the two basic translation vectors e1 and e2 is parallel to at least one of the long axis d1 and the short axis d2 of the light receiving surface 50.

The mechanism of the present embodiment will be described.

In a case where the plurality of microstructures 32 exert an optical function by causing a phase gradient to act on light, if there is a phase difference of π [rad] or more between two adjacent microstructures 32, a desired phase profile cannot be reproduced. Furthermore, even in a case where there is no such an abrupt phase difference, it is preferable that the phase difference between the adjacent microstructures 32 is small in order to maintain satisfactory light use efficiency. Therefore, it is desired to shorten the distance between adjacent microstructures 32 and to accurately control the shape of the microstructures 32 occupying the space in the microscopic region. However, it is difficult to perform microfabrication with such a microscopic scale, and in reality, stray light is generated in a region where the phase profile changes sharply, and the light use efficiency is reduced.

In general, a light collecting element such as an optical element (metalens) including the optical functional layer 30 requires a steeper phase change for strongly acting on light as the light collecting element is more separated from the optical axis Ax. Therefore, as shown in FIG. 5, the largest phase change occurs in the peripheral edge portion in the diagonal direction of the light receiving surface 50. An arrangement of the microstructures where the distance between the microstructures 32 adjacent to each other in a diagonal direction of the light receiving surface 50 is large leads to generation of stray light and a reduction in light use efficiency in such a peripheral region F.

For example, in the case where the microstructures 32 are arranged in a square lattice pattern, when the direction in which the distances between the microstructures 32 are minimum is aligned with the direction of one of the diagonal axes d3 of the light receiving surface 50, the distances between the microstructures 32 are increased in the direction of the other of the diagonal axes d4. In this case, a peripheral edge portion F having poor light use efficiency and imaging characteristics is generated asymmetrically with respect to the light receiving surface 50.

In this regard, according to the present embodiment, at least one of the basic translation vectors e1 and e2 of the arrangement of the microstructures 32 is parallel to at least one of the long axis d1 and the short axis d2 of the light receiving surface 50. That is, the arrangement direction of the microstructures 32 is set to correspond to the arrangement direction of the light receiving elements 52 on the light receiving surface 50. Thus, the above-described asymmetric characteristic deterioration can be suppressed.

A specific example of the arrangement of the microstructures 32 is described below. Table 1 below shows the parallelism of the two basic translation vectors e1 and e2 with respect to the long, short, and diagonal axes of the light receiving surface 50 in each of the arrangement examples.

### [Table 1]

TABLE I

| | | | PARALLEL TO |
|---|---|---|---|
| ARRANGEMENT | PARALLEL TO | PARALLEL TO | LONG AXIS OR SHORT |
| SHAPE OF | LONG AXIS OR | BOTH LONG AXIS | AXIS AND ONE OF |
| MICROSTRUCTURE | SHORT AXIS | AND SHORT AXIS | DIAGONAL AXES |
| SQUARE LATTICE | YES | YES | NO |
| FACE-CENTERED | YES | NO | GOOD |
| RECTANGULAR | | | |
| LATTICE | | | |
| HEXAGONAL | YES | NO | YES |
| LATTICE | | | |
| RECTANGULAR | YES | YES | NO |
| LATTICE | | | |

### Arrangement Example 1: Tetragonal Lattice

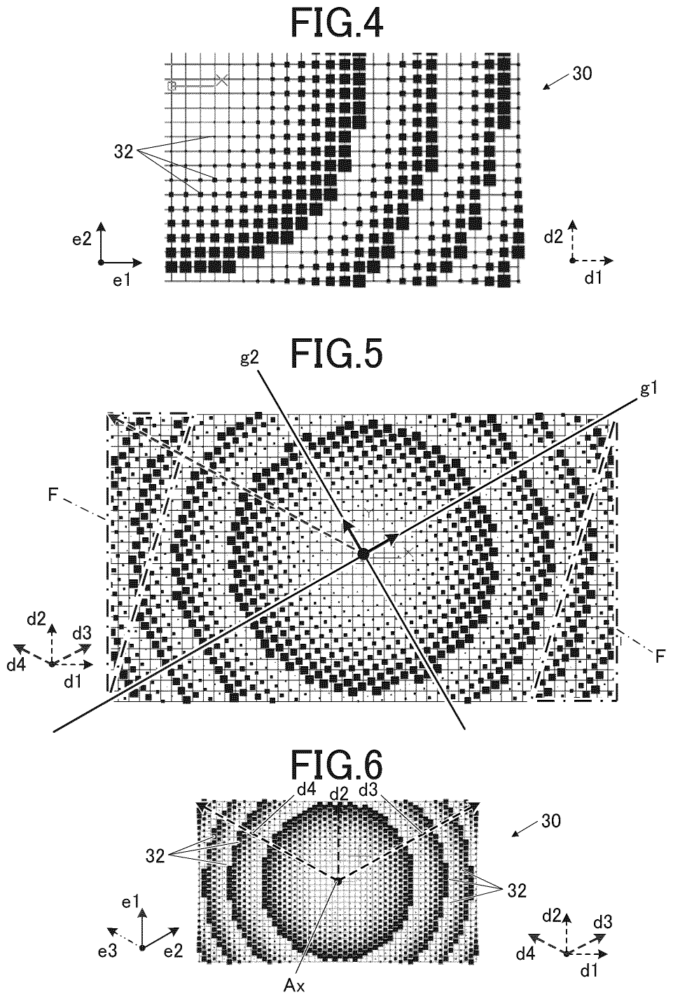

FIG. 3 is a plan view of an optical functional layer 30 in which the microstructures 32 are arranged in a tetragonal lattice pattern, and FIG. 4 is a partial enlarged view of FIG. 3. The thin lines in FIG. 4 indicate the arrangement direction of the light receiving elements 52 on the light receiving surface 50. FIGS. 3 and 4 show the microstructures 32 each having a square shape, but this does not limit the shape of the microstructures 32. The same applies to the subsequent drawings.

As shown in FIGS. 3 and 4, in this arrangement example, the plurality of microstructures 32 are arranged in a square lattice pattern. That is, the two basic translation vectors e1 and e2 of the microstructures 32 are orthogonal to each other and have the same length.

The two basic translation vectors e1 and e2 of the microstructures 32 are parallel to the long axis d1 and the short axis d2 of the light receiving surface 50, respectively. Thus, as the optical functional layer 30 acts symmetrically with respect to the long axis d1 and the short axis d2 of the light receiving surface 50, asymmetric image distortion can be suppressed.

### Arrangement Example 2: Face-Centered Rectangular Lattice

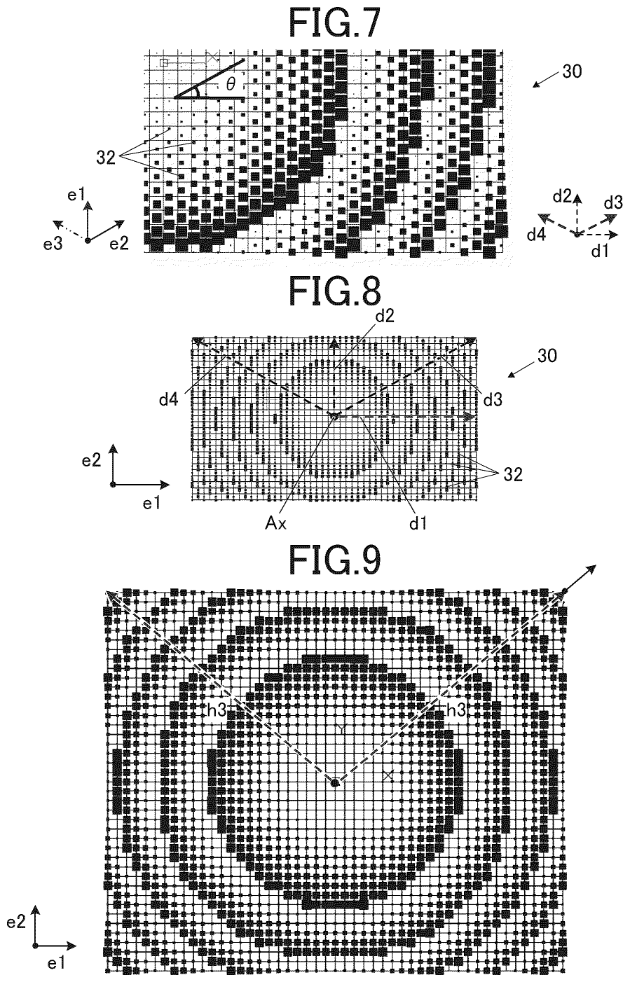

FIG. 6 is a plan view of the optical functional layer 30 in which the microstructures 32 are arranged in a face-centered rectangular lattice pattern, and FIG. 7 is a partial enlarged view of FIG. 6. The thin lines in FIG. 7 indicate the arrangement direction of the light receiving elements 52 on the light receiving surface 50.

As shown in FIGS. 6 and 7, in this arrangement example, the plurality of microstructures 32 are arranged in a face-centered rectangular lattice pattern. That is, the two basic translation vectors e1 and e2 of the microstructures 32 have the same size and form a non-90 degree angle. The basic translation vectors e1 and e2 of the face-centered rectangular lattice are not uniquely chosen.

In the microstructures 32, one basic translation vector e1 is parallel to the long axis d1 or the short axis d2 of the light receiving surface 50, and the other basic translation vector e2 is parallel to one of the two diagonal axes d3 and d4. In the examples of FIGS. 6 and 7, one basic translation vector e1 is parallel to the short-axis d2 of the light receiving surface 50, and the other basic translation vector e2 is parallel to the diagonal axis d3. Thus, compared to the square lattice pattern the microstructures 32 are arranged at a higher density along the diagonal axes d3 and d4 of the light receiving surface 50 where the largest phase change occurs. Therefore, it is possible to suppress generation of stray light at the four corners of the light receiving surface 50 and a decrease in light use efficiency.

In a face-centered rectangular lattice, a difference vector e3 (=e1−e2) between the two basic translation vectors e1 and e2 may be included in the basic translation vectors. In this case, it is preferable that the basic translation vector e3 is parallel to the other diagonal axis d4 different from the one diagonal axis d3 parallel to the basic translation vector e2.

In this arrangement example, one of the two basic translation vectors e1 and e2 is inclined at an inclination angle θ of 29.36 degrees with respect to the long axis d1 of the light receiving surface 50. This is the direction of the diagonal axes d3 and d4 of the light receiving surface 50 having an aspect ratio of 16:9. At this time, the distances to six adjacent microstructures 32 surrounding one microstructure 32 are constant at the magnitudes of the basic translation vectors e1 and e2. Therefore, the optical functional layer 30 can be produced with the same microscopic scale as in the case of the square lattice pattern, that is, with the same size of the basic translation vectors e1 and e2. That is, the microstructures 32 can be arranged at a high density along the diagonal axes d3 and d4 of the light receiving surface 50 without changing the microscopic scale from the case of the square lattice pattern. The inclination angle θ may be within a range of 30±5 degrees.

### Arrangement Example 3: Hexagonal Lattice

When the basic translation vectors e1 and e2 of the arrangement of the microstructures 32 have an inclination angle of 30 degrees with respect to the long axis d1 of the light receiving surface 50, a hexagonal lattice which is an exceptional example of the face-centered rectangular lattice is obtained. Since the arrangement of the microstructures 32 in this case is substantially the same as that in the case of the face-centered rectangular lattice (FIGS. 6 and 7), the illustration thereof is omitted.

One of the two basic translation vectors e1 and e2 of the microstructures 32 is parallel to the long axis d1 or the short axis d2 of the light receiving surface 50. Also in this case, the same effect as in the case of the face-centered rectangular lattice of the arrangement example 2 is obtained. That is, since the optical functional layer 30 acts symmetrically with respect to the long axis d1 and the short axis d2 of the light receiving surface 50, it is possible to suppress asymmetric image distortion. Further, the microstructures 32 are arranged at a high density along the diagonal axes d3 and d4 of the light receiving surface 50 where there is the largest phase change. Therefore, it is possible to suppress generation of stray light at the four corners of the light receiving surface 50 and a decrease in light use efficiency.

### Arrangement Example 4: Rectangular Lattice

FIG. 8 is a plan view of an optical function layer 30 in which the microstructures 32 are arranged in a rectangular lattice pattern.

As shown in FIG. 8, in this arrangement example, the microstructures 32 are arranged in a rectangular lattice pattern. That is, the two basic translation vectors e1 and e2 of the microstructures 32 are orthogonal to each other and have different lengths. In the example of FIG. 8, the microstructures 32 are arranged at a high density along the direction of the short axis d2 of the light receiving surface 50.

The two basic translation vectors e1 and e2 of the microstructures 32 are parallel to the long axis d1 and the short axis d2 of the light receiving surface 50, respectively. Accordingly, the microstructures 32 can be arranged at a high density along the diagonal axes d3 and d4 of the light receiving surface 50, compared to a case where the microstructures 32 are arranged in a square lattice pattern. Therefore, although microfabrication at a higher level may be required as compared with the case of the square lattice pattern, it is possible to suppress generation of stray light at the four corners of the light receiving surface 50 and a decrease in light use efficiency. Furthermore, since the optical functional layer 30 acts symmetrically with respect to the long axis d1 and the short axis d2 of the light receiving surface 50, it is possible to suppress asymmetric image distortion.

### <About “Parallel”>

The term “parallel” between the basic translation vector of the microstructures 32 and each axis of the light receiving surface 50 includes, in addition to complete parallel, substantial parallel in which an angle formed therebetween is within a predetermined range. An angular range that can be regarded as substantially parallel is, for example, ++10 degrees, and more preferably, +5 degrees. This point will be described below.

In the example of FIG. 5, unlike the microstructures 32 of the present embodiment, one (g1) of the basic translation vectors of the microstructures is parallel to one of the diagonal axes d3 of the light receiving surface 50, and is inclined by 29.36 degrees with respect to the long axis d1 of the light receiving surface 50. If this inclination is within +10 degrees, it is possible to reduce the area on the light receiving surface 50 where asymmetric distortion occurs. Further, the other (g2) of the basic translation vectors of the arrangement of the microstructures is inclined by 31.28 degrees with respect to the other diagonal line d4 of the light receiving surface 50. Due to this inclination, when viewed in the direction of the diagonal axis d4 of the light receiving surface 50, the distance between adjacent microstructures becomes long, resulting in stray light and a decrease in light use efficiency.

When the microstructures 32 are arranged in a square lattice pattern, the basic translation vectors e1 and e2 are parallel to the long axis d1 and the short axis d2 of the light receiving surface 50. In comparison to such microstructures 32, as shown in FIG. 9, a light receiving sensor is shown in which the light receiving surface is substantially a square and the diagonal axes h3 are inclined by 40 degrees with respect to the basic translation vector of the microstructures. In this case, the diagonal axis h3 of the light receiving surface 50 substantially coincide with the direction of 45 degrees (the upper right solid line arrow in the drawing) in which the adjacent fine structures are most distant from each other. This results in stray light and a reduction in light use efficiency.

On the other hand, in the case of the face-centered rectangular lattice arrangement of the present embodiment shown in FIG. 6, one of the basic translation vectors e1 is inclined by 29.36 degrees with respect to the long axis d1 of the light receiving surface 50, and is parallel to one of the diagonal axes d3 of the light receiving surface 50. The other basic translation vector e2 inclines at 150.64 degrees relative to the long axis d1 of the light receiving surface 50 and is parallel to the other diagonal axis d4 of the light receiving surface 50.

As described above, when the basic translation vectors e1 and e2 of the arrangement of the microstructures 32 and the diagonal axes d3 and d4 of the light receiving surface 50 are within the range of +10 degrees, the direction in which the distances between the adjacent microstructures 32 are short substantially coincides with the diagonal axes d3 and d4 of the light receiving surface 50 that require the largest phase change. Thus, a decrease in light use efficiency can be suppressed.

### [Distribution of Shapes of Microstructures]

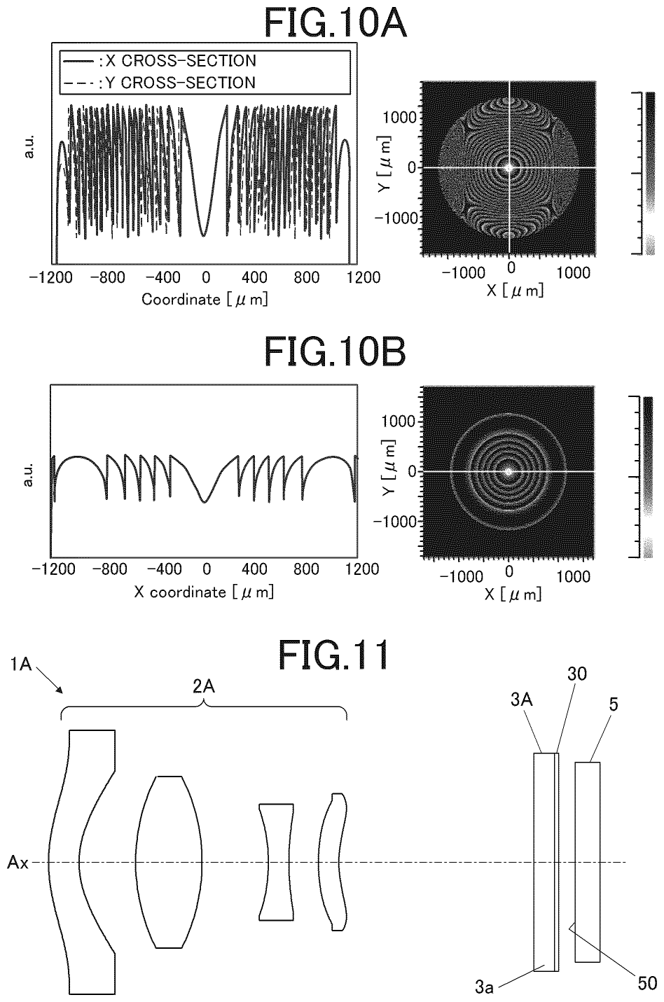

FIG. 10A shows an example of the distribution of the shapes of the microstructures 32 based on the XY polynomials. FIG. 10B shows an example of the distribution of the shapes of the microstructures of a comparative example of the embodiment, the example being based on an even-aspherical surface. In these drawings, a graph of the distribution of the shapes (widths) of the microstructures is shown on the left side, and a heat map of the phase profile of the microstructures is shown on the right side. Furthermore, the X-axis and the Y-axis in the drawings correspond to, for example, the long axis d1 and the short axis d2 of the light receiving surface 50.

The shape distribution of the microstructures 32 on the base material 3a is defined by a predetermined shape parameter. Here, the “shape” of the microstructure 32 includes at least one of a cross-sectional shape, a size (width), a height, an orientation, and a material of the microstructure 32.

To be specific, the distribution of the shapes (for example, widths) of the microstructures 32 on the base material 3a is set based on the Zernike polynomial or the XY polynomial. More specifically, the distribution of the shapes of the microstructures 32 is set so as to correspond to a phase profile defined by a Zernike polynomial or an XY polynomial. Thus, as shown in FIG. 10A, the shapes of the microstructures 32 are set so as to be distributed axisymmetrically with respect to each of the long axis d1 and the short axis d2 of the light receiving surface 50 with a point on the optical axis Ax as the origin. That is, unlike the case where the distribution of the shapes is set on the basis of the topological profile defined by the even-aspherical surface as shown in FIG. 10B, the distribution of the shapes of the microstructures 32 is not point-symmetric with respect to the origin. Therefore, the shapes of the microstructures 32 can be distributed in a manner corresponding to the long axis d1 and the short axis d2 of the light receiving surface 50. In this way, by applying different forces to light in the direction of the long axis d1 and the direction of the short axis d2, an improvement in light use efficiency can be expected.

The microstructures 32 do not have to be based on the Zernike polynomials or the XY polynomials as long as the distribution of the shapes of the microstructures 32 is set to be axisymmetric with respect to each of the long axis d1 and the short axis d2 of the light receiving surface 50 with the point on the optical axis Ax as the origin.

### Technical Effects of the Present Embodiment

As described above, according to the present embodiment, the plurality of microstructures 32 are arranged in a lattice pattern along the two basic translation vectors e1 and e2 in the flat optical functional layer 30 disposed closer to the object side than the light receiving surface 50. At least one of the two basic translation vectors e1 and e2 is parallel to at least one of the long axis d1 and the short axis d2 of the light receiving surface 50.

That is, the arrangement direction of the microstructures 32 is set to correspond to the arrangement direction of the light receiving elements 52 on the light receiving surface 50. Thus, it is possible to suppress asymmetric characteristic deterioration caused by the rectangular shape of the light receiving surface 50. Therefore, the microstructures 32 can be suitably arranged with respect to the shape of the light receiving surface 50 having the plurality of light receiving elements 52.

In addition, according to the present embodiment, the plurality of microstructures 32 may be arranged in a square lattice pattern, and the two basic translation vectors e1 and e2 may be parallel to the long axis d1 and the short axis d2 of the light receiving surface 50, respectively.

This can suppress asymmetric image distortion.

Furthermore, according to the present embodiment, the microstructures 32 may be arranged in a face-centered rectangular lattice pattern, one e1 of the basic translation vectors is parallel to the long axis d1 or the short axis d2 of the light receiving surface 50, and the other e2 of the basic translation vectors may be parallel to the diagonal-axis d3 of the light receiving surface 50.

Thus, the microstructures 32 can be arranged at a high density along the diagonal axes d3 and d4 of the light receiving surface 50 where there is the largest phase change. Therefore, it is possible to suppress generation of stray light and a decrease in light use efficiency.

In this case, the other one e2 of the basic translation vectors is inclined by 30±5 degrees with respect to the long axis d1 of the light receiving surface 50. Thus, the microstructures 32 can be arranged at a high density along the diagonal axis d3 of the light receiving surface 50 without changing the microscopic scale from the case of the square lattice pattern.

In addition, according to the present embodiment, the microstructures 32 may be arranged in a hexagonal lattice pattern, and any one of the two basic translation vectors e1 and e2 may be parallel to the long axis d1 or the short axis d2 of the light receiving surface 50.

This can suppress asymmetric image distortion.

In addition, according to the present embodiment, the plurality of microstructures 32 are arranged in a rectangular lattice pattern, and the two basic translation vectors e1 and e2 are parallel to the long axis d1 and the short axis d2 of the light receiving surface 50, respectively.

Thus, the microstructures 32 can be arranged at a higher density along the diagonal axes d3 of the light receiving surface 50 compared to in the case of the square lattice pattern.

According to the present embodiment, the shapes of the microstructures 32 are distributed axisymmetrically with respect to each of the long axis d1 and the short axis d2 of the light receiving surface 50 with a point on the optical axis Ax as the origin.

Thus, the shapes of the microstructures 32 can be suitably distributed in accordance with the long axis d1 and the short axis d2 of the light receiving surface 50.

Further, according to the present embodiment, the distribution of the shapes of the microstructures 32 on the base material 3a is set based on the Zernike polynomial or the XY polynomial.

Thus, the axisymmetric distribution pattern of the microstructures 32 with respect to each of the long axis d1 and the short axis d2 of the light receiving surface 50 can be suitably controlled.

### [Others]

Although an embodiment of the present invention has been described above, embodiments to which the present invention can be applied are not limited to the above-described embodiment and modification examples thereof, and can be appropriately modified without departing from the spirit and scope of the present invention.

For example, the light receiving optical system 1 including the lens 2, the first parallel plate 3, the second parallel plate 4, and the light receiving sensor 5 is shown as an example in the above-described embodiment. However, the present embodiment can be widely applied to optical elements and light receiving optical systems including an optical functional layer (optical functional surface) in which a plurality of microstructures are arranged. There is no particular limitation to optical elements other than those including an optical functional layer.

For example, as shown in FIG. 11, a light receiving optical system 1A may be provided in which an optical functional layer 30 is provided on a cover glass 3A (optical element) for protecting the light receiving sensor 5. A specific configuration of the optical system 2A disposed closer to the object side than the cover glass 3A is not particularly limited. In this case, the cover glass 3A can be, for example, a metalens capable of aberration correction. Thus, the resolution characteristics can be improved while suppressing the cost and a change in the optical system 2A.

Although embodiments of the present invention have been described and shown in detail, the disclosed embodiments are made for purposes of illustration and example only and not limitation. The scope of the present invention should be interpreted by terms of the appended claims.

What is claimed is:

1. An optical element that is disposed closer to an object side than a light receiving surface is, the optical element comprising:
a base material; and a planar optical functional layer including a plurality of microstructures arranged on the base material,
wherein the light receiving surface is formed in a rectangular shape having a long axis and a short axis, and a plurality of light receiving elements are arranged in a lattice pattern along the long axis and the short axis on the light receiving surface,
wherein the plurality of microstructures is arranged in a lattice pattern along two basic translation vectors,
wherein one of the basic translation vectors is parallel to at least one of the long axis and the short axis of the light receiving surface.

2. The optical element according to claim 1,
wherein the plurality of microstructures is arranged in a square lattice pattern, and the two basic translation vectors are respectively parallel to the long axis and the short axis of the light receiving surface.

3. The optical element according to claim 1,
wherein the plurality of microstructures is arranged in a face-centered rectangular lattice pattern, one of the two basic translation vectors is parallel to the long axis or the short axis of the light receiving surface, and an other one of the two basic translation vectors is parallel to a diagonal axis of the light receiving surface.

4. The optical element according to claim 3,
wherein the other one of the two basic translation vectors is inclined at 30±5 degrees with respect to the long axis of the light receiving surface.

5. The optical element according to claim 1,
wherein the plurality of microstructures is arranged in a hexagonal lattice pattern, and one of the two basic translation vectors is parallel to the long axis or the short axis of the light receiving surface.

6. The optical element according to claim 1,
wherein the plurality of microstructures is arranged in a rectangular lattice pattern, and the two basic translation vectors are respectively parallel to the long axis and the short axis of the light receiving surface.

7. The optical element according to claim 2,
wherein a size of each of the plurality of microstructures is equal to or smaller than a main design wavelength of the optical functional layer, and a distribution of shapes on the base material is defined by a predetermined shape parameter,
wherein the shapes of the plurality of microstructures are distributed symmetrically with respect to each of the long axis and the short axis of the light receiving surface with a point on an optical axis as an origin.

8. The optical element according to claim 7,
wherein the distribution of the shapes of the plurality of microstructures on the base material is determined based on a Zernike polynomial or an XY polynomial.

9. A light receiving optical system comprising:
a light receiving surface; and
a planar optical functional layer that is disposed closer to an object and that includes a plurality of microstructures arranged on a base material,
wherein the light receiving surface is formed in a rectangular shape having a long axis and a short axis, and a plurality of light receiving elements are arranged in a lattice shape along the long axis and the short axis on the light receiving surface,
wherein the plurality of microstructures is arranged in a lattice pattern along two basic translation vectors,
wherein one of the basic translation vectors is parallel to at least one of the long axis and the short axis of the light receiving surface.

10. The light receiving optical system according to claim 9, further comprising:
a cover glass disposed closer to an object than the light receiving surface is,
wherein the optical functional layer is formed on a surface of the cover glass.
